(19) United States
(12) Patent Application Publication
(10) Pub. No.: US 2002/0038994 A1
(43) Pub. Date: Apr. 4, 2002

(54) Shadow mask

(76) Inventors: Yoshinori Hirobe, Tokyo-to (JP); Takuya Ogio, Tokyo-to (JP); Akira Makita, Tokyo-to (JP)

Correspondence Address: Ladas & Parry, Suite 1200, 224 South Michigan Avenue, Chicago, IL, 60604, US

(21) Appl. No.: 09/930,321

(22) Filed: Aug. 15, 2001

(30) Foreign Application Priority Data
Aug. 16, 2000 (JP) P2000-246611
Sep. 19, 2000 (JP) P2000-283501

(51) Int. Cl. H01J 29/80

(52) U.S. Cl. 313/402

(57) ABSTRACT

A shadow mask is formed with through holes in a predetermined arrangement or pattern. Each of the through holes has a rear surface side hole portion through which an electron beam enters and a front surface side hole portion through which the electron beam outgoes so as to form a beam spot having a predetermined shape on a surface to be irradiated. The front surface side hole portion of the through hole formed at a peripheral portion of the shadow mask has an opening hole area smaller than that of the front surface side hole portion of the through hole formed at a central portion thereof. The front surface side hole portion of the through hole formed at a peripheral portion of the shadow mask may have substantially an elliptical shape having an opening hole width in a direction normal to a virtual line extending from a center of the shadow mask, and the width is made smaller than that of the front surface side hole portion of the through hole formed at a central portion thereof.

### BACKGROUND OF THE INVENTION

The present invention relates to a shadow mask utilized for, for example, a cathode ray tube (Braun tube), and more particularly, to a shadow mask which is utilized for a flat-type Braun tube and excellent in an impact strength.

One example of a shadow mask having a general structure is, for example, shown in FIG. 8 as an illustrated sectional view. With reference to FIG. 8, a shadow mask 51 is mounted to a cathode ray tube (Braun tube) for the purpose of forming a beam spot having a circular shape on a fluorescent surface or screen of the cathode ray tube. Such shadow mask 51 is formed with through holes, each having a predetermined shape, arranged in a predetermined pattern. The through holes are formed through an etching treatment to a thin metal plate.

The through hole is composed of a rear surface side hole portion through which an electron beam enters and a front surface side hole portion through which the electron beam exits. The front side hole portion has a dimension larger than that of the rear surface side hole portion, and areas of the front surface side hole portions and areas of the rear surface side hole portions are formed so as to provide substantially the same sizes, respectively, at both the surface sides of the shadow mask 51.

More specifically, as shown in FIG. 8, a central through hole 52a formed to the central (side) portion of the shadow mask 51 differs from those 52b formed to the peripheral (side) portion thereof in the forming positions of the front surface side hole portions 53a and 53b with respect to the rear surface side hole portions 54a and 54b, respectively. However, the respective front surface side hole portions 53a and 53b have substantially the same hole dimension and area size in spite of difference in their locations to the shadow mask 51. Furthermore, the respective rear surface side hole portions 54a and 54b also have substantially the same hole dimension and area size in spite of difference in their locations to the shadow mask 51. Further, the through holes 52b on the peripheral side of the shadow mask 51 are formed such that the hole dimension and area size of the front surface side hole portion 53b are formed to be slightly larger than those of the front surface side hole portion 53a of the central side through hole so as to prevent the electron beam from being shielded at the portion forming a side wall section of a peripheral side portion of the front surface side hole portion 54b of the shadow mask 51.

In a case where the shadow mask of the type mentioned above is applied to a general cathode ray tube having a curved surface on a display surface side, there causes substantially no problem even if a dropping impact be applied to the cathode ray tube.

However, in a case where such shadow mask is applied to a flat-type cathode ray tube having a flat display surface side and a fluorescent surface side having an R-shape larger than the general cathode ray tube, there causes a fear, through experiment, of being deformed in shape of recess at the central portion of the shadow mask by the dropping impact or like (see broken line portion in FIG. 10).

### SUMMARY OF THE INVENTION

An object of the present invention is to substantially eliminate defects or drawbacks encountered in the prior art mentioned above and to provide a shadow mask particularly to be mounted to a flat -type cathode ray tube to improve strength against impact such as dropping impact or like, the shadow mask being formed with through holes having front surface side hole portions having opening hole areas or opening hole widths which are changed in preferred manners.

This and other objects can be achieved according to the present invention by providing, in one aspect, a shadow mask which has a front surface and a rear surface to which through holes are formed in a predetermined arrangement, each of these through holes having a rear surface side hole portion through which an electron beam enters and a front surface side hole portion through which the electron beam outgoes so as to form a beam spot having a predetermined shape on a surface to be irradiated,

wherein the front surface side hole portion of the through hole formed at a peripheral portion of the shadow mask has an opening hole area smaller than that of the front surface side hole portion of the through hole formed at a central portion thereof.

In preferred embodiments of this aspect, supposing that the opening hole area of the front surface side hole portion of the through hole formed at the central portion is 100, the opening hole area of the front surface side hole portion of the through hole formed at the peripheral portion is in a range of 80 to 96.

The opening hole areas of the front surface side hole portions of the through holes are continuously changed at a predetermined rate of change in accordance with a distance from the central portion of the shadow mask.

The through holes formed to an entire outer peripheral portion have opening hole areas having substantially the same size, and the through holes formed between the through holes formed at the central portion of the shadow mask and the through holes formed to the entire outer peripheral portion have thereof front surface side hole portions having opening hole areas continuously changed at a predetermined rate of change.

The shadow mask is mounted to a flat-type cathode ray tube.

According to this aspect of the shadow mask of the present invention, since the front surface side hole portion of the through hole formed at a peripheral portion of the shadow mask has an opening hole area smaller than that of the front surface side hole portion of the through hole formed at a central portion thereof, the peripheral portion of the shadow mask includes many metal portions not etched in comparison with the central portion thereof, so that the central portion can be suitably supported by the peripheral portion having relatively heavy weight and rigidity, and hence, the shadow mask after the mounting to the cathode ray tube cannot be deformed even if an impact such as dropping impact be applied.

According to the preferred embodiment of this aspect, the shadow mask has a distribution of strength in form of concentric circle, and for this reason, balance in the strength of the shadow mask becomes extremely regular and the strength of the shadow mask can be made gradually larger from the center of the shadow mask towards the peripheral portion thereof. The shadow mask thus manufactured is not deformed even if any dropping impact or like be applied after the mounting to the cathode ray tube.

Moreover, since the through holes formed to the outermost peripheral portion of the shadow mask have substantially the same opening hole area, the shadow mask has a balance of the strength extremely regularly in the peripheral portion, and the strength thereof can be made gradually regularly larger from the center of the shadow mask towards the peripheral portion thereof by changing, at predetermined rate of change, the opening hole areas of the front surface side hole portions, gradually to be small. Hence, the shadow mask thus manufactured is not deformed even if any dropping impact or like be applied after the mounting to the cathode ray tube.

Even in a case where such shadow mask as mentioned above is applied to a flat-type cathode ray tube having a large R portion on the fluorescent surface side, the shadow mask never be deformed on the application of impact such as dropping impact.

In another aspect of the present invention, there is provided a shadow mask which has a front surface and a rear surface to which through holes are formed in a predetermined arrangement, each of these through holes having a rear surface side hole portion through which an electron beam enters and a front surface side hole portion through which the electron beam outgoes so as to form a beam spot having a predetermined shape on a surface to be irradiated,

wherein the front surface side hole portion of the through hole formed at a peripheral portion of the shadow mask has substantially an elliptical shape in which an opening hole width in a direction normal to a virtual line extending from a center of the shadow mask is made smaller than that of the front surface side hole portion of the through hole formed at a central portion thereof.

In preferred embodiments of this aspect, the opening hole width of the front surface side hole portion of the through hole formed at the peripheral portion of the shadow mask has a size not less than 1.46 time of a thickness of the shadow mask.

The opening hole widths of all the front surface side hole portions including of the front surface side hole portions at the peripheral portion are continuously changed at a predetermined rate of change in accordance with a distance from the central portion of the shadow mask.

Opening hole widths of all the front surface side hole portions including the front surface side hole portions at the peripheral portion are substantially the same at the front surface side hole portions at the outermost peripheral portion of the shadow mask and the opening hole widths of the front surface side hole portions of the through holes formed between the through holes formed at the central portion of the shadow mask and the through holes formed to the outermost peripheral portion are continuously changed at a predetermined rate of change.

The shadow mask is mounted to a flat-type cathode ray tube.

According to this aspect of the present invention, since the front surface side hole portion of the through hole formed at a peripheral portion of the shadow mask has substantially an elliptical shape, in which an opening hole width in a direction normal to a virtual line extending from a center of the shadow mask is made smaller than that of the front surface side hole portion of the through hole formed at a central portion thereof, the peripheral portion of the shadow mask includes many metal portions not etched in comparison with the central portion thereof, so that the central portion can be suitably supported by the peripheral portion having relatively heavy weight, and hence, the shadow mask after the mounting to the cathode ray tube cannot be deformed even if an impact such as dropping impact be applied.

According to the preferred embodiment of this aspect, the opening hole width of the front surface side hole portion has a size not less than 1.46 time of a thickness of the shadow mask, so that any deformation or like never be formed even in the application of dropping impact or like after the mounting to the cathode ray tube.

Further, the front surface side hole portions formed to the entire surface area of the shadow mask including the peripheral portion of the shadow mask have opening hole widths which are gradually changed at a predetermined rate of change to be smaller in accordance with the distance from the center of the shadow mask, so that the shadow mask has a distribution of strength in form of concentric circle, and for this reason, balance in the strength of the shadow mask becomes extremely regular and the strength of the shadow mask can be made gradually larger from the center of the shadow mask towards the peripheral portion thereof. The shadow mask thus manufactured is not deformed even if any dropping impact or like be applied after the mounting to the cathode ray tube.

Furthermore, since the opening hole widths of the front surface side hole portions are made substantially the same at the outermost peripheral portion, the shadow mask can be formed to have the same strength at that peripheral portion, and moreover, the opening hole widths of the front surface side hole portions of the through holes formed between the central portion and the outermost peripheral portion are changed continuously at a predetermined rate of change, so that the strength of the shadow mask can be changed gradually from the central portion of the shadow mask towards the peripheral portion thereof. Hence, the shadow mask thus manufactured is not deformed even if any dropping impact or like be applied after the mounting to the cathode ray tube.

The nature and further characteristic features of the present invention will be made more clear from the following descriptions made with reference to the accompanying drawings.

### BRIEF DESCRIPTION OF THE DRAWINGS

In the accompanying drawings:

FIG. 1 represents a shadow mask according to one example of an embodiment of the present invention and includes

FIG. 1A being a sectional view of a through hole formed to a central portion of the shadow mask and

FIG. 1B being a sectional view of a through hole formed to a peripheral portion of the shadow mask, the through hole being cut by a virtual line extending from a center of the shadow mask;

FIG. 2 represents a shadow mask according to another example of the present invention and includes

FIG. 2A being a sectional view of a through hole formed to a central portion of the shadow mask and

FIG. 2B being a sectional view of a through hole formed to a peripheral portion of the shadow mask, the through hole being cut by a virtual line extending from a center of the shadow mask;

FIG. 3 represents a shadow mask according to a further example of the present invention and includes

FIG. 3A being a sectional view of a through hole formed to a central portion of the shadow mask and

FIG. 3B being a sectional view of a through hole formed to a peripheral portion of the shadow mask, the through hole being cut by a virtual line extending from a center of the shadow mask;

FIG. 4 represents the one example of the shadow mask of the present invention and includes

FIG. 4A being a front view of a through hole formed to the central portion of the shadow mask and

FIG. 4B being a front view of a through hole formed to the peripheral portion thereof;

FIG. 5 is an illustration showing an arrangement of the positional relationship between through holes formed to various portions of the shadow mask;

FIG. 6 is an illustration showing an example of continuously changing an opening hole width of the through hole of the shadow mask;

FIG. 7 is an illustration showing another example of continuously changing an opening hole width of the through hole of the shadow mask;

FIG. 8 is an illustrated sectional view showing a shadow mask having a general structure;

FIG. 9 includes

FIG. 9A and FIG. 9B respectively illustrating front views of through holes formed to a central portion and a peripheral portion of a shadow mask of a general structure; and

FIG. 10 is an illustration showing a cathode ray tube to which a shadow mask is mounted.

### DESCRIPTION OF THE PREFERRED EMBODIMENTS

Preferred embodiments of the shadow masks of the present invention will be described hereunder with reference to the accompanying drawings.

Shadow masks according to first and second embodiments of the present invention are formed through an etching treatment to thin metal plates so as to provide through holes having predetermined shapes and predetermined patterns. The pattern has an arrangement of the through holes in approximately closest packed structure or like structure. A shadow mask having such through hole arrangement is mounted to a cathode ray tube (Braun tube) for the purpose of magnetic shield, formation of beam spot having a predetermined shape on a fluorescent surface of the cathode ray tube or so on. The beam spot may have a circular shape, a slot shape (approximately rectangular shape), or like. The present invention is applicable to any shape of beam spot, and accordingly, a shadow mask forming a circular beam spot will be explained hereunder as one example for the sake of convenience, but the present invention is not limited thereto.

The through holes having the following shapes will be first described.

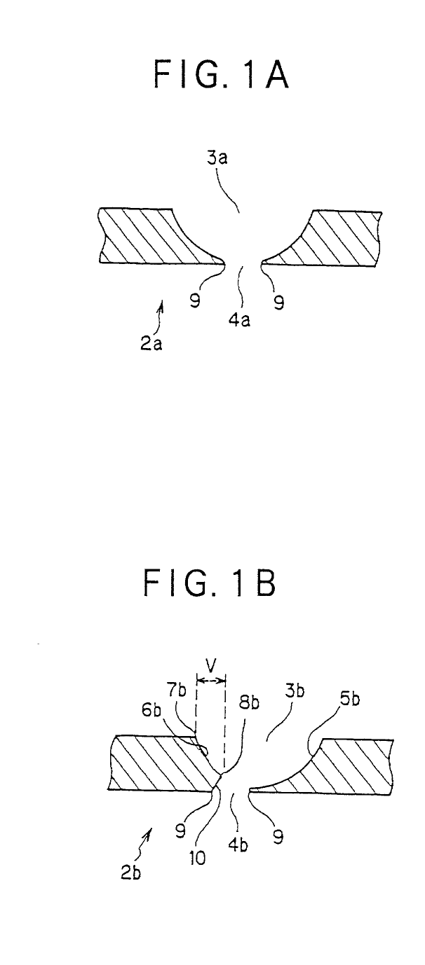

With reference to FIGS. 1 to 4, the through holes 2a and 2b are composed of rear surface side hole portions 4a and 4b through which electron beams enter and front surface side hole portions 3a and 3b which are positioned on a fluorescent surface side of a cathode ray tube and through which the electron beams outgo. The front surface side hole portions 3a and 3b have opening surface areas larger than those of the rear surface side hole portions 4a and 4b, respectively. Portions of the electron beams can be shielded by end portions 9 and/or side wall portions 10 of the rear surface side hole portions 4a and 4b, and circular beam spots with predetermined sizes can be formed on predetermined portions on the fluorescent surface of the cathode ray tube.

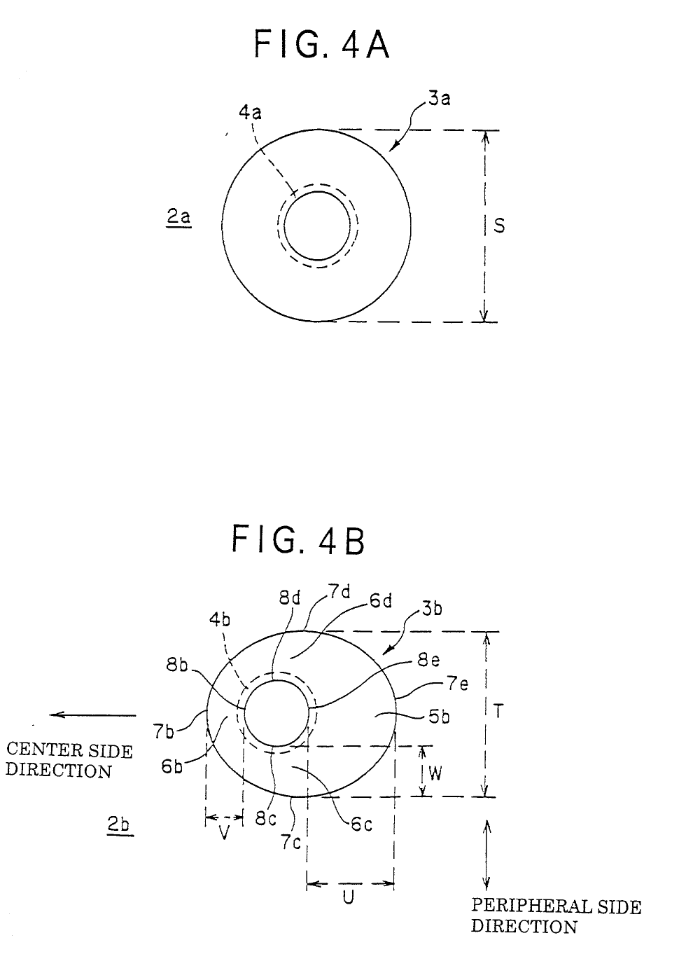

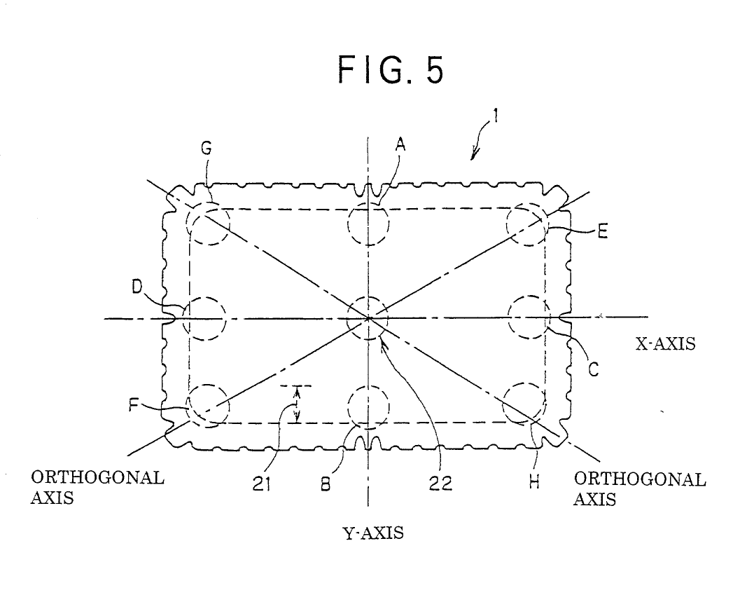

The positional relationships between the front surface side hole portions 3a and 3b and the rear surface side hole portions 4a and 4b, shown in FIGS. 4A to 4C, differ at the peripheral portion 21 and the central portion 22 of the shadow mask 51 shown in FIG. 5. Furthermore, even on the same peripheral side portion 21, the positional relationship between the front surface side hole portions 3a and 3b and the rear surface side hole portions 4a and 4b differ from each other at portions of X- and Y-axis portions and orthogonal axis portions. Such difference is made for preventing the electron beams from being shielded at a portion of the outer peripheral side side wall portion 5b of the side wall section of the front surface side hole portion of the shadow mask. According to such positional relationship, the circular beam spots with the predetermined sizes can be formed on the predetermined portions on the fluorescent surface of the cathode ray tube. Herein, the term “central (side) portion 22” of the shadow mask 1 is a portion including a center of the shadow mask 1 and, on the other hand, the term “peripheral (side) portion 21” of the shadow mask 1 is a portion including an outer peripheral portion thereof such as shown with capitals A to H in FIG. 5, which designate herein portions in a range inside by about 10 mm from the through holes on the most outer peripheral portions.

More specifically, at the central portion 22 of the shadow mask 1, the electron beam is emitted almost directly towards the shadow mask 1, so that the through hole at the central portion 22 may have substantially the same central position of its rear surface side hole portion 4a and its front surface side hole portion 3a. On the other hand, at the peripheral portion 21 of the shadow mask 1, the electron beam is emitted obliquely towards the shadow mask 1, so that it is necessary to change the central positions of the rear surface side hole portions 4b and the front surface side hole positions 3a from each other in accordance with the positions A to H (FIG. 5) at which the through holes 2b are formed. That is, the front surface side hole portions 3a of the through holes 2b are formed in a manner shifted towards outer peripheral side of the shadow mask 1 from the rear surface side hole portions 4b in accordance with the fact that the respective through holes 2b are formed in what directions with respect to the center of the shadow mask 1. Furthermore, As the through hole forming position approaches from the central side portion 22 towards the peripheral side portion 21 of the shadow mask 1, the front surface side hole portions 3b of the through holes 2b are formed so as to be gradually shifted towards the outer peripheral side portions of the shadow mask 1 comparing with the rear surface side hole portions 4b.

In the embodiment described above, the shape of the front surface side hole portion 3b of the shadow mask 1 of this embodiment is made gradually flatten from the circular opening hole shape towards an elliptical or near opening hole shape from the central side portion 22 towards the peripheral side portion 21 of the shadow mask 1 so as not to shield the electron beam more than necessity.

Further, in another (i.e., second) embodiment, it is desirable for the front surface side hole portion 3b of the shadow mask 1 to have a substantially elliptical shape which is made gradually flatten from the circular opening hole shape towards an elliptical or near opening hole shape from the central side portion 22 towards the peripheral side portion 21 of the shadow mask 1 so as not to shield the electron beam more than necessity.

Hereunder, the shadow masks according to the first and second embodiments will be independently described with reference to the opening hole areas and opening hole widths of the front surface side hole portion of the through hole.

[Shadow Mask of First Embodiment]

The aimed object mentioned above can be achieved according to the shadow mask of the first embodiment, in which the opening hole area T of the front surface side hole portion 3b of the through hole 2b formed at the peripheral portion 21 of the shadow mask 1 is made smaller than the opening hole area S of the front surface side hole portion 3a of the through hole 2a formed at the central portion 22 of the shadow mask 1.

The relationship between the opening hole areas T and S mentioned above will be optionally set in consideration of the size of a cathode ray tube to which the shadow mask 1 is mounted, the size of “R” portion on the fluorescent surface side of the cathode ray tube, a thickness of the shadow mask 1, the shape of the through hole such as circular shape, slot shape, etc., a mounting condition of the shadow mask 1 supported by a support member, working condition at the time of press molding, the magnitude of dropping impact and so on.

In the shadow mask 1 of the first embodiment, supposing that the opening hole area S of the front surface side hole portion 3a at the central side portion 22 is set to 100, for example, it is desired for the opening hole area T of the front surface side hole portion 3b of the peripheral side portion 21 to be in a range within 80 to 96, preferably, 84 to 92, and more preferably, 86 to 90.

In the shadow mask 1 formed with such relationship as mentioned above, the peripheral side portion 21 has a metal portion which is not subjected to the etching treatment as compared with the central side portion 22. For this reason, the central side portion 22 of the shadow mask 1 has a weight lighter than that of the peripheral side portion 21 and, hence, is supported by the peripheral side portion 21 having high strength and weight larger than that of the central side portion 22. Accordingly, even if the dropping impact is applied to the cathode ray tube to which the shadow mask 1 has been mounted, any severe or fatal deformation will not be caused to the shadow mask 1.

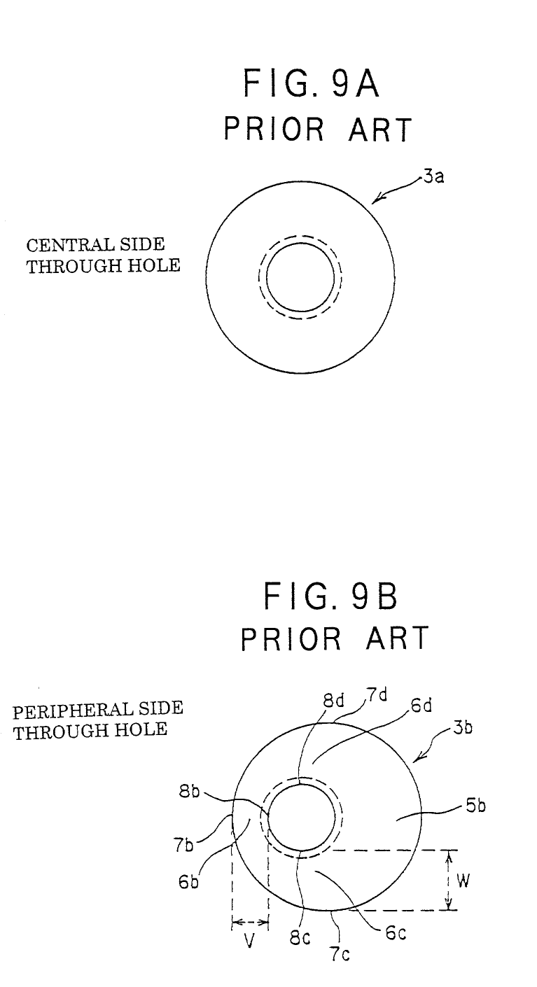

Further, the opening hole area T of the front surface side hole portion 3b at the peripheral side portion 21 can be adjusted by reducing the etching amount to the side wall section of the front surface side hole portion 3b. More specifically, the side wall section 6b on the center side of the shadow mask 1 is directed towards the center of the front surface side hole portion 3b by changing the etching mask pattern or adjusting the etching conditions. According to such manner, the opening hole area T can be reduced as shown in FIGS. 1 and 9, for example.

Furthermore, the opening hole area T may be reduced in a manner similar to that mentioned above by directing side wall sections 6c and 6d on the side normal to a virtual line connecting the through hole 2b and the center of the shadow mask 1 towards the center of the front surface side hole portion 3b (FIG. 9). In the present invention, the adjustments and/or procedures mentioned above can be simultaneously or independently adopted.

Among the above adjustments, in the case where the side wall section 6b is directed towards the center of the front surface side hole portion 3b, when a length V between a coordinate position of an end portion 7b of the front surface side hole portion 3b and a coordinate position of a edge line portion 8b of the through hole 2b is made shorten more than necessity, the positional precision of that edge line portion 8b becomes worse. As a result, there may cause a case where the though holes 2b are formed with different diameters, and accordingly, it is desirable to set the above length V in consideration of these points.

In the other case, in which the side wall sections 6c and 6d are directed to the center of the front surface side hole portion 3b, this case represents the shadow mask concerning the second embodiment of the present invention which will be mentioned hereinlater. In this case, however, when lengths W between coordinate positions of end portions 7c and 7d of the front surface side hole portion 3b and coordinate positions of edge line portions 8c and 8d of the through hole 2b is made shorten more than necessity, the positional precision of those edge line portions 8c and 8d becomes worse. This may result in the unevenness of the size of the through holes 2b, and moreover, in the shielding of the electron passing the through hole 2b being more than necessity. Accordingly, it will be required to set the length W in consideration of the above matters.

Further, from the matters mentioned above, it is to be noted that the upper limit (for example, 96) of the range of the opening hole area T in the case of the opening hole area S being assumed as 100 has a meaning that the upper limit prescribes the limit of the opening hole area S at which any deformation to the shadow mask is not caused even if a dropping impact be applied after the mounting thereof to the cathode ray tube. On the other hand, the lower limit (for example, 80) of the range of the opening hole area T in the case of the opening hole area S being assumed as 100 has a meaning that the upper limit prescribes the limit of the opening hole area T at which the central side side wall section can be shifted towards the outer peripheral direction of the shadow mask 1 as far as the electron beam can pass with no trouble.

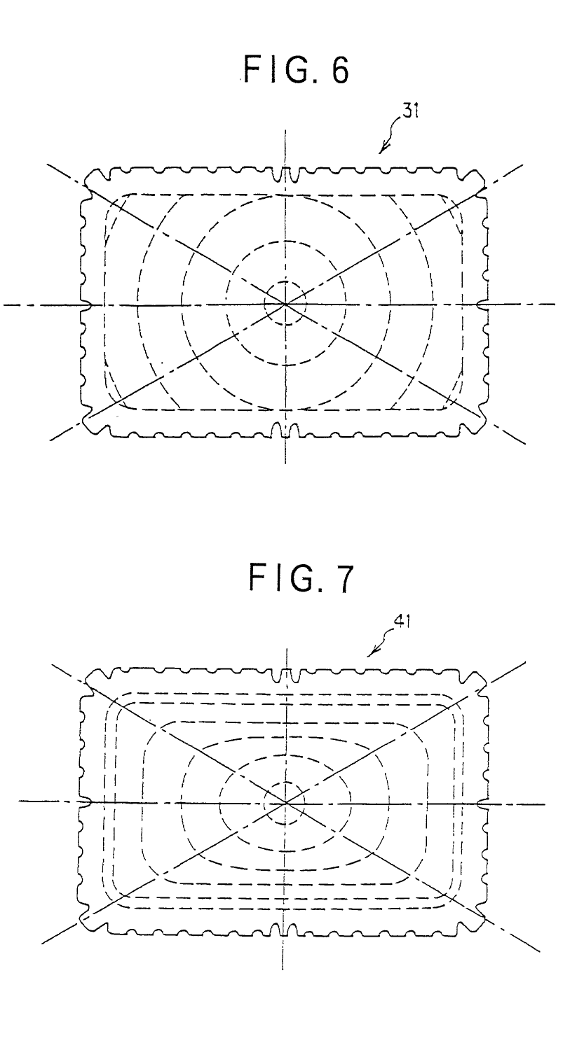

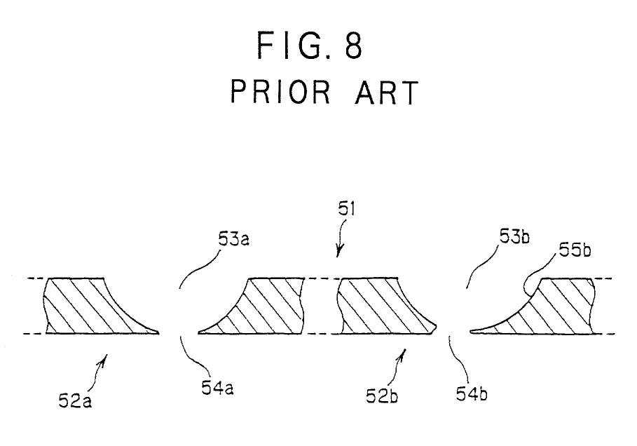

Furthermore, the following two modified examples will be applicable to the relationship between the opening hole area S of the front surface side hole portion 3a at the central portion 22 of the shadow mask 1 and the opening hole area T of the front surface side hole portion 3b of the peripheral portion 21 of the shadow mask 1. In this connection, FIGS. 6 and 7 are schematic front views showing examples in which the opening hole area of the shadow mask is continuously changed.

FIG. 6 shows a first modified example of a shadow mask according to the first embodiment, in which the opening hole area of the front surface side hole portion of the through hole is continuously changed with a predetermined rate of change in accordance with a distance from the center of the shadow mask 31.

In this modified example, the through holes located to positions on a concentric circle having the same distance from the center of the shadow mask 31 or near have the same opening hole areas of the front surface side hole portions of the through holes. The rate of change of the opening hole area changing in accordance with the distance from the center of the shadow mask 1 may be represented primarily or secondarily, or represented by primary (linear) expression or secondary expression, and hence, is not especially limited. Further, as one example, the rate of change desirable in a case of a shadow mask applicable for the structure of the dimension of 17 inches will be expressed as A−1.06659×10⁻⁷×R², in which A denotes an opening hole area (mm²) of the central through hole of the shadow mask and R is distance (mm) from the center of the shadow mask. Further, in shadow masks other than for 17 inches, the opening hole areas will change in a manner substantially similar to that mentioned above.

The shadow mask 31 of the first modified embodiment of the structure mentioned above has a distribution of strength in form of concentric circle, and for this reason, balance in the strength of the shadow mask 31 becomes extremely regular and the strength of the shadow mask 31 can be made gradually larger from the center of the shadow mask 31 towards the peripheral portion thereof. The shadow mask 31 thus manufactured is not deformed even if any dropping impact or like be applied after the mounting to the cathode ray tube.

In the description mentioned above, the expression “continuously change (or is continuously changed)” will include concepts of both of the case that the opening hole areas or the widths thereof of the front surface side hole portions of the adjacent through holes are changed literally continuously in accordance with a predetermined equation and the case that the opening hole areas or the widths thereof of the front surface side hole portions in a predetermined region are gradually changed in that region in accordance with a predetermined equation.

FIG. 7 shows a second modified example of a shadow mask according to the first embodiment, in which the through holes formed at the peripheral portion of a shadow mask 41 with the same opening hole, and an opening hole area of a through hole positioned between the through hole at the peripheral portion of the shadow mask 41 and the through hole at the central portion thereof is continuously changed with a predetermined rate of change.

The rate of change changing from the through hole at the peripheral portion towards the through hole at the central portion, both having the same opening hole area, may be represented primarily or secondarily, or represented by primary (linear) expression or secondary expression, and hence, is not especially limited. Further, as one example, the rate of change desirable in a case of a shadow mask for dimension of 17 inches will be expressed at a plane coordinate position (x, y) specifying the position from the center of the shadow mask by an opening hole area (mm²) of A−1.96884×10⁻¹⁰×x²−3.66068×10₋₁₀×y²+1.62342×10⁻¹⁴×(x×y)², in which the plane coordinate (x, y) is a coordinate length (mm) from the center. Further, in shadow masks other than for 17 inches, the opening hole areas will change in a manner substantially similar to that mentioned above.

The shadow mask 41 of the second modified embodiment of the structure mentioned above has a balance of the strength of the shadow mask 41 becomes extremely regular and the strength thereof can be made gradually larger from the center of the shadow mask 41 towards the peripheral portion thereof. The shadow mask 41 thus manufactured was not deformed even if any dropping impact or like be applied after the mounting to the cathode ray tube.

[Shadow Mask of Second Embodiment]

The aimed object mentioned hereinbefore can be achieved according to the shadow mask of the second embodiment, in which the front surface side hole portion 3b formed at the peripheral (side) portion 21 of the shadow mask 1 so as to provide substantially an elliptical shape wherein an opening hole area T in a direction P normal to a virtual line extending from the center of the shadow mask 1 is made smaller than an opening hole area S of the front surface side hole portion 3a formed to the central portion of the shadow mask.

The relationship between the opening hole areas T and S mentioned above will be optionally set in consideration of the size of a cathode ray tube to which the shadow mask 1 is mounted, the size of “R” portion on the fluorescent surface side of the cathode ray tube, a thickness of the shadow mask 1, the shape of the through hole such as circular shape, slot shape, etc., a mounting condition of the shadow mask 1 supported by a support member, working condition at the time of press molding, the magnitude of dropping impact and so on.

Specifically, in the shadow mask 1 of the second embodiment, it is preferred for the front surface side hole portion 3b at the peripheral portion 21 of the shadow mask 1 to have the opening hole width T of not more than 1.46 time of the plate thickness of the shadow mask, preferably of not more than 1.40 time, and more preferably, not more than 1.36 time.

In the through hole at the peripheral portion 21 having the opening hole width T in such range has a reduced space volume of the front surface side hole portion 3b. This reduction in the space volume of the front surface side hole portion 3b will result in the space reduction of all the through holes at the peripheral portion 21 of the shadow mask 1, so that the through holes at the peripheral portion 21 will include relatively many metal portions to which any etching treatment is not done in comparison with the through hole 2a of the central portion 22. For this reason, the central portion 22 of the shadow mask 1 provides a weight relatively smaller than that of the peripheral portion 21, and moreover, the central portion 22 is supported by the peripheral portion 21 having relatively large weight and high strength. As a result, even if any dropping impact or like be applied to the shadow mask after the mounting to the cathode ray tube, the shadow mask 1 is substantially free from deformation or like.

The size of the opening hole width T will be adjusted in a desirable range mentioned above by changing the etching mask pattern, the etching conditions or the like.

In a case, for example, where the opening hole width T of the front surface side hole portion 3b at the peripheral portion 21 is not more than 1.46 time of the plate thickness of the shadow mask, when the length W between a coordinate position of the end portion 7c and 7d of the front surface side hole portion 3b and a coordinate position of the edge line portions 8c and 8d of the through hole 2b is made more than necessity, the positional precision of the edge line portions 8c and 8d becomes worse, As a result, the sizes of the through holes 2b may not be made uniform or the electron beam passing the through holes 2b may be shielded more than necessity. Accordingly, it is desired to set the length W and the opening hole width T including this length W in consideration of the above matters. Further, the “edge line portion 8e” is a portion formed from a side wall section 10e of the rear surface side hole portion 4b and a side wall section 5b of the front surface side hole portion 3b.

The reason why the opening hole width T is prescribed to be not more than 1.46 time of the plate thickness of the shadow mask is to prevent the shadow mask from being deformed even if any stress such as dropping impact or like be applied after the mounting to the cathode ray tube.

On the other hand, the lower limit of the opening hole width T is prescribed so that the sizes of the through holes 2b are made uniform and the electron beam passing through the through hole is not shielded more than necessity. More specifically, in comparison with the plate thickness of the shadow mask, it is preferred for the opening hole width T to have a size of not less than 1.2 time of the plate thickness, preferably, not less than 1.24 time, and more preferably, not less than 1.26 time. Further, strictly, although this value is slightly influenced by the size of the shadow mask, the size of the through hole or shape thereof, it will be desired for the through hole to have the opening hole width T in the range mentioned above for the shadow mask of 17 to 21 inches.

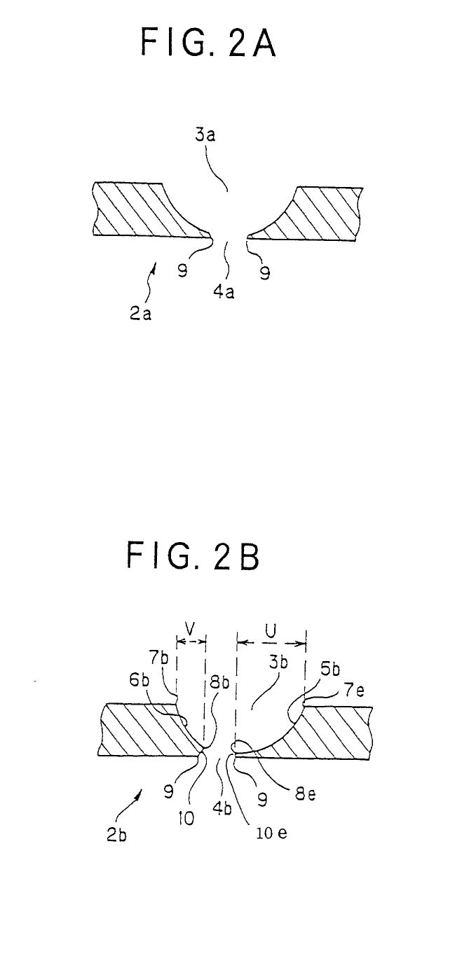

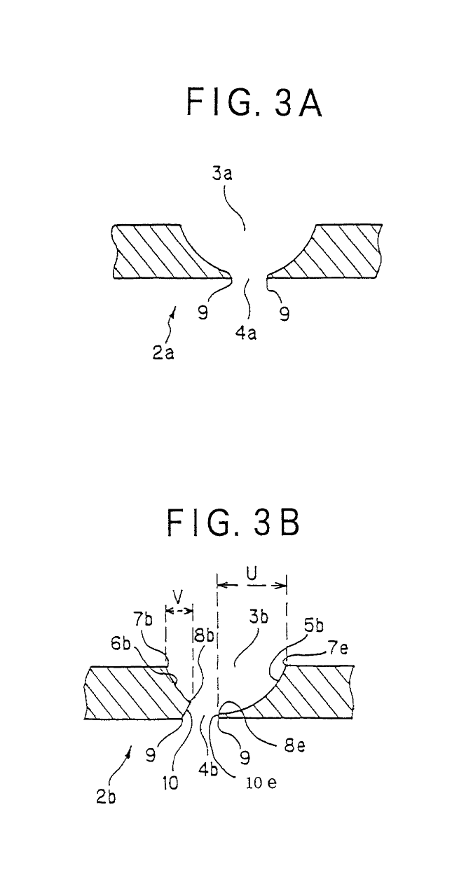

Furthermore, according to the shadow mask of the present invention, in addition to the method of reducing the opening hole width T, the metal portion of the front surface side hole portion 3b can be relatively increased in area, as shown in FIG. 3, by directing the side wall section 6b on the central side of the shadow mask 1 towards the center of the front surface side hole portion 3b, whereby the strength of the shadow mask at the peripheral portion 21 will be advantageously increased, which will be made clear through the comparison of FIGS. 2 and 3.

Further, at the time of directing the side wall section 6b on the center side of the shadow mask 1 towards the center portion of the front surface side hole portion 3b, when the length V between a coordinate position of the end portion 7b of the front surface side hole portion 3b and a coordinate position of the edge line portion 8b of the through hole 2b is made more than necessity, the positional precision of the edge line portion 8b becomes worse, As a result, the diameters of the through holes 2b may not be made uniform. Accordingly, although the length V is set in consideration of the above matters, in an actual manufacturing, the lower limit of this length V is about 10 μm in view of desired maintenance of an outer appearance.

Further, a length U (FIGS. 2 and 3) between a coordinate position of an end portion 7e of the front surface side hole portion 3b and a coordinate position of a edge line portion 8e the through hole 2b is a matter of design which is automatically set by an incident angle of the electron beam based on the coordinate position at which the through hole 2b is formed, a height in section (height from an end portion 9 of the rear surface side hole portion 4b to the edge line portion 8e) and a thickness t of the shadow mask plate. A mode for continuously changing the opening hole width will be described hereunder.

It is desired that the opening hole widths of the front surface side hole portions are formed so as to continuously change at respective portions on the shadow mask, and the following two modified examples will be adopted.

In this connection, FIGS. 6 and 7 are schematic front views showing examples in which the opening hole width at the front surface side hole portion (opening hole area) of the shadow mask is continuously changed.

A first modified example of a shadow mask according to the second embodiment will be represented by FIG. 6, in which the opening hole width T on the front surface side hole portion of the through hole is continuously changed with a predetermined rate of change in accordance with a distance from the center of the shadow mask 31.

In this modified example, the through holes located to positions on a concentric circle having the same distance from the center of the shadow mask 31 or near have the same opening hole width T of the front surface side hole portions of the through holes. The rate of change of the opening hole width T changing in accordance with the distance from the center of the shadow mask 1 may be represented primarily or secondarily, or represented by primary (linear) expression or secondary expression, and hence, is not especially limited. Further, as one example, the rate of change desirable in a case of a shadow mask of the dimension of 17 inches will be expressed as T (mm)=(α−0.000183×R)×0.130÷t (mm), in which a is an opening hole width of the front surface side hole portion formed at the central portion of the shadow mask, R is a distance from the center of the shadow mask and t is a thickness thereof. Further, in this example, it will be desired that the opening hole width T at the front surface side hole portion on the periphery side portion 21 of the shadow mask, prescribed as an area inside by 10 mm from the most outer periphery thereof is adjusted to be not more than 1.6 time of the plate thickness of the shadow mask. Further, in shadow masks other than for 17 inches, it will be desired to set the opening hole widths so as to be changed in a manner substantially similar to that mentioned above.

The shadow mask 31 of this modified embodiment of the structure mentioned above has a distribution of strength in form of concentric circle, and for this reason, balance in the strength of the shadow mask 31 becomes extremely regular and the strength of the shadow mask 31 can be made gradually larger from the center of the shadow mask 31 towards the peripheral portion thereof. The shadow mask 31 thus manufactured was not deformed even if any dropping impact or like be applied after the mounting to the cathode ray tube.

FIG. 7 shows a second modified example of a shadow mask according to the second embodiment, in which the through holes are formed at the peripheral portion of a shadow mask 41 with the same opening hole width T at the front surface side hole portions on the most outer peripheral side of the shadow mask, and the opening hole widths T of the front surface side hole portions on the outer peripheral side and those on the central side of the shadow mask 41 are continuously with predetermined rates of change.

In the changing mode mentioned above, the opening hole widths T of the front surface side hole portions of this embodiment are changed towards the through hole on the central side from the most outer peripheral side, both through holes having the same opening hole width, and the rate of change of the width will be represented primarily or secondarily, or represented by primary (linear) expression or secondary expression, and hence, is not especially limited. Further, as one example, the rate of change desirable in a case of a shadow mask for dimension of 17 inches will be expressed, in relation to the thickness of the shadow mask, at a plane coordinate position (x, y) specifying the position from the center of the shadow mask by an opening hole width T (mm) of {α−1.570×10⁻⁶×x²−2.727×10⁻⁶×y²+1.361×10⁻¹⁰×(x×y)²}×0.130÷t, in which α is an opening hole width (mm) of the front surface side hole portion of the through hole formed to the central side portion of the shadow mask and the plane coordinate (x, y) is a coordinate length (mm) from the center. Further, in this example, it will be desired that the opening hole width T at the front surface side hole portion on the periphery side portion 21 of the shadow mask, prescribed as an area inside by 10 mm from the most outer periphery thereof, is adjusted to be not more than 1.46 time of the plate thickness of the shadow mask. Further, in shadow masks other than for 17 inches, it will be desired to set the opening hole widths so as to be changed in a manner substantially similar to that mentioned above.

The shadow mask 41 of the second modified embodiment of the structure mentioned above has a balance of the strength of the shadow mask 41 becomes extremely regular and the strength thereof can be made gradually larger from the center of the shadow mask 41 towards the peripheral portion thereof formed with the same strength. The shadow mask 41 thus manufactured is not deformed even if any dropping impact or like be applied after the mounting to the cathode ray tube. This second modified example will be applicable in a further desired manner to the shadow mask of the present invention in comparison with the first modified example mentioned above.

Hereunder, the way or mode of mounting the shadow mask according to the present invention to the cathode ray tube (Braun tube) will be described.

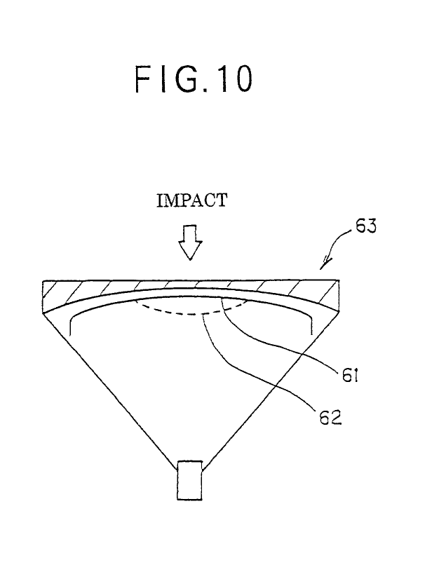

With reference to FIG. 10 showing a state that a shadow mask is mounted to a flat-type cathode ray tube 63, the solid line represents the shadow mask 61 after a dropping impact is applied thereto and the broken line represents a conventional shadow mask 62 which is deformed in recess shape by a dropping impact applied thereto.

The shadow mask 61 of the present invention is preferably utilized for the flat-type cathode ray tube 31 having a display surface side in flat shape and a fluorescent surface side having a large R portion in comparison with a general cathode ray tube. According to the structure of the present invention, the central portion of the shadow mask 61 never be deformed even after the dropping impact be applied.

The shadow masks of the first and second embodiments of the present invention mentioned above will be manufactured by the following methods. The present invention is of course not limited to these methods.

The shadow mask 1 is manufactured by a known method including etching treatments or processes by a continuous inline system. For example, first, water-soluble colloidal photoresist is applied to both surfaces of a metal thin plate and then dried. Thereafter, a photomask, to which a pattern having a form of the front surface side hole portions mentioned above is formed, is disposed tightly closely to the front surface of the metal thin plate and a photomask, to which a pattern having a form of the rear surface side hole portions mentioned above is formed, is disposed tightly closely to the rear surface of the metal thin plate. Under this state, the metal plate is exposed to ultraviolet ray such as high pressure mercury and thereafter developed by using water. The positional relationship between the photomasks and the shapes of the photomasks, on which the patterns of the front and rear surface side hole portions are formed, are designed and arranged in consideration of the positional relationship between obtained photomasks, on which the patterns of the front and rear surface side hole portions are formed, and the sizes thereof. Exposed portions of the metal of which periphery is covered by a resist film image are formed in various forms in accordance with the difference in etching advancing speeds at respective portions. Further, The etching working is performed, after the thermal treatment, by spraying ferric chloride solution from both surface sides. Thereafter, post processes such as washing, peeling and so on are carried out continuously, thus manufacturing a shadow mask according to the present invention.

The present invention will be further explained hereunder through the comparison between concrete Examples and Comparative Examples, the details of which are shown in Table 1 on the last page of this specification.

### EXAMPLE 1

A shadow mask 1 according to the first embodiment mentioned above for a cathode ray tube (Braun tube) having 17 inches and formed of an Fe—Ni alloy in shape of plate having a thickness of 0.13 mm was manufactured by a general shadow mask manufacturing method mentioned hereinbefore.

This shadow mask is a type in which a circular beam spot is focused (formed) on the fluorescent surface of the cathode ray tube, and as shown in Table 1, density of the through holes 2a, 2b to be formed is 2498/cm² and the opening hole area of each of the rear surface side hole portions 4a, 4b was about 0.00887 mm² at each of the respective portions. Further, with the front surface side hole portions 3a, 3b, the opening hole area was about 0.03398 mm² at the central portion of the shadow mask 1 and about 0.02955 mm² at the peripheral portion (F, G, H) thereof. Furthermore, the opening hole areas of the front surface side hole portions of the through holes formed between the central portion and the peripheral portion of the shadow mask were changed to be continuously smaller while maintaining a primary equation in accordance with the distances from the center of the shadow mask.

In the shadow mask obtained through the above processes, supposing that the opening hole area S at the front surface side hole portion 3a at the central portion of the shadow mask is 100, the opening hole areas T of the front surface side hole portions 3b at the peripheral portions (E, F, G, H) were 86 and 97, which are smaller than the opening hole area S. The through holes 2b having such front surface side hole portions 3b are formed such that the side wall sections 6b constituting the front surface side hole portions 3b are directed towards the center of the front surface side hole portion 3b. Further, each of the through hole 2b having such front surface side hole portion 3b includes metal amount larger, by about 0.002165 μg, than that of the through hole 2a having the front surface side hole portion 3a of the center portion.

The shadow mask thus formed was mounted to the cathode ray tube, and thereafter, an impact load of more than 30 G was applied to the cathode ray tube. The shadow mask mounted to the cathode ray tube was, however, not damaged and deformed.

### EXAMPLE 2

A shadow mask 1 according to the first embodiment mentioned above for a cathode ray tube (Braun tube) having 19 inches and formed of an Fe—Ni alloy in shape of plate having a thickness of 0.13 mm was manufactured by the same method mentioned above for the first Example 1.

In this shadow mask, as shown in Table 1, density of the through holes 2a, 2b to be formed is 1768/cm² and the opening hole area of each of the rear surface side hole portions 4a, 4b was about 0.01011 mm² at each of the respective portions. Further, with the front surface side hole portions 3a, 3b, the opening hole area was about 0.03398 mm² at the central portion of the shadow mask 1 and about 0.03024 mm² at the entire peripheral portion thereof. Furthermore, the opening hole areas of the front surface side hole portions of the through holes formed between the central portion and the peripheral portion of the shadow mask were changed to be continuously smaller while maintaining a primary equation between the center and the peripheral portion of the shadow mask.

In the shadow mask obtained through the above processes, supposing that the opening hole area S at the front surface side hole portion 3a at the central portion of the shadow mask is 100, the opening hole areas S of the front surface side hole portions 3b at the entire peripheral portions were 88.99, which are smaller than the opening hole area S. The through holes 2b having such front surface side hole portions 3b are formed such that the side wall sections 6b constituting the front surface side hole portions 3b are directed towards the center of the front surface side hole portion 3b. Further, each of the through hole 2b having such front surface side hole portion 3b includes metal amount larger, by about 0.001829 μg, than that of the through hole 2a having the front surface side hole portion 3a of the center portion.

The shadow mask thus formed was mounted to the cathode ray tube, and thereafter, an impact load of more than 30 G was applied to the cathode ray tube. The shadow mask mounted to the cathode ray tube was, however, not damaged and deformed.

### EXAMPLE 3

A shadow mask 1 according to the second embodiment mentioned above for a cathode ray tube (Braun tube) having 17 inches and formed of an Fe—Ni alloy in shape of plate having a thickness t of 0.13 mm was manufactured by the same method as that in the first Example 1.

This shadow mask is a type in which a circular beam spot is focused (formed) on the fluorescent surface of the cathode ray tube, and as shown in Table 1, density of the through holes 2a, 2b to be formed is 2498/cm² and the opening hole area of each of the rear surface side hole portions 4a, 4b was about 0.00887 mm² at each of the respective portions. Further, with the front surface side hole portions 3a, 3b, the opening hole area was about 0.03398 mm² at the central portion of the shadow mask 1 and about 0.02955 mm² at the entire outermost peripheral portion thereof. Furthermore, the opening hole width T of the front surface side hole portions was about 0.175 mm at the outermost peripheral portion of the shadow mask 1 which is 1.35 time of the thickness t of the shadow mask plate, and the opening hole width T of the front surface side hole portions of the through holes formed between the central portion and the outermost peripheral portion of the shadow mask were changed to be continuously smaller based on the secondary equation in accordance with the distances from the center of the shadow mask. More specifically, the opening hole width T was changed in accordance with the equation of −0.000001019×R². At this time, the opening hole width T of the front surface side hole portions in the region (A to H portions) inside by 10 mm from the outermost peripheral portion was made within a range of 1.35 to 1.40 time of the plate thickness t.

Further, each of the through hole 2b having such front surface side hole portion 3b includes metal amount larger, by about 3 μg, than that of the through hole 2a having the front surface side hole portion 3a of the center portion.

The shadow mask thus formed was mounted to the flat-type cathode ray tube, and thereafter, an impact load of more than 30 G was applied to the cathode ray tube. The shadow mask mounted to the cathode ray tube was, however, not damaged and deformed.

### EXAMPLE 4

A shadow mask 1 according to the second embodiment mentioned above for a cathode ray tube (Braun tube) having 19 inches and formed of an Fe—Ni alloy in shape of plate having a thickness t of 0.13 mm was manufactured by the same method mentioned above for the first Example 1.

In this shadow mask, as shown in Table 1, density of the through holes 2a, 2b to be formed is 1768/cm² and the opening hole area of each of the rear surface side hole portions 4a, 4b was about 0.00887 mm² at each of the respective portions. Further, with the front surface side hole portions 3a, 3b, the opening hole area was about 0.03398 mm² at the central portion of the shadow mask land about 0. 03024 mm² at the entire peripheral portion thereof. Furthermore, the opening hole width T of the front surface side hole portions 3a, 3b of the through holes was about 0.175 mm at the outermost peripheral portion of the shadow mask 1 which was 1.35 time of the plate thickness t of the shadow mask. The opening hole widths T of the front surface side hole portions of the through holes formed between the central portion and the outermost peripheral portion of the shadow mask were changed to be continuously smaller at a secondary equation in accordance with the distance from the center of the shadow mask. More specifically, the widths T were changed at the equation of −0.000000748×R². At this time, the opening hole width T of the front surface side hole portions in the region (A to H portions) inside by 10 mm from the outermost peripheral portion was made within a range of 1.35 to 1.40 time of the plate thickness t.

Further, each of the through hole 2b having such front surface side hole portion 3b includes metal amount larger, by about 2.5 μg, than that of the through hole 2a having the front surface side hole portion 3a of the center portion.

The shadow mask thus formed was mounted to the flat-type cathode ray tube, and thereafter, an impact load of more than 30 G was applied to the cathode ray tube. The shadow mask mounted to the cathode ray tube was, however, not damaged and deformed.

### COMPARATIVE EXAMPLES 1-3

Shadow masks for cathode ray tubes (Braun tubes) having 17 to 21 inches were manufactured with opening hole areas or opening hole widths of the front surface hole portions of the through holes as shown in Table 1 in accordance with the method carried out for the Example 1. In the Comparative Examples 1 and 2, the opening hole area of the front surface side hole portion was made larger towards the outer peripheral portion from the central portion of the shadow mask. In the Comparative Example 3, the opening hole areas of the front surface side hole portions of the through holes were all made equal in the entire region of the shadow mask.

The shadow masks thus formed were mounted to the flat-type cathode ray tubes, and thereafter, an impact load of more than 30 G was applied to the cathode ray tubes. The shadow mask mounted to the cathode ray tube were damaged and deformed such as shown in FIG. 10.

The above results of the Examples and Comparative Examples are shown in the following Table 1.

TABLE 1

| | | | | Opening | | | Opening Hole Area T | Opening | Plate |
|---|---|---|---|---|---|---|---|---|---|
| | Thick- | | Density | Hole Area | Opening Hole Area | | of Front Surface Side | Hole Width | Thick- |
| | ness of | | of | at Rear | at Front Surface | | Hole Portion at | (mm) of | ness |
| | Thin | | Through | Surface | Side Hole Portion | | Peripheral Portion in | Front | Ratio |
| | Metal | Size | Hole | Side Hole | (mm²) | | Case of Supposing | Surface | of |
| | Plate | (Type) | (number/ | Portion | Central | Peripheral | Opening Hole A at Cen- | Side Hole | Shadow |
| | (μm) | (inch) | cm²) | (mm²) | Side | Side | tral portion being 100 | Portion | Mask |
| Example 1 | 0.13 | 17 | 2498 | 0.00887 | 0.03398 | 0.02955 | 86.97 | — | — |
| Example 2 | 0.13 | 19 | 1768 | 0.01011 | 0.03398 | 0.03024 | 88.99 | — | — |
| Example 3 | 0.13 | 17 | 2498 | 0.00887 | 0.03398 | 0.02955 | — | 0.175 | 1.35 |
| Example 4 | 0.13 | 19 | 1768 | 0.01011 | 0.03398 | 0.03024 | — | 0.175 | 1.35 |
| Com. Ex 1 | 0.13 | 17 | 1974 | 0.00914 | 0.03398 | 0.03497 | 102.90 | 0.212 | 1.65 |
| Com. Ex 2 | 0.12 | 19 | 1691 | 0.01031 | 0.03464 | 0.03546 | 102.38 | 0.210 | 1.75 |
| Com. Ex 3 | 0.13 | 21 | 1840 | 0.00933 | 0.03293 | 0.03293 | 100.00 | 0.195 | 1.50 |

*) Com. Ex: Comparative Example

As mentioned hereinbefore, according to the shadow mask of the first and second embodiments of the present invention, the peripheral portion of the shadow mask includes many metal portions, which were not subjected to the etching treatment, more than that at the central portion thereof. Accordingly, the central portion of the shadow mask has light weight compared with the peripheral portion. Moreover, the central portion is supported by such relatively heavy and strong peripheral portion, so that the shadow mask is free from damage or deformation after the mounting to the cathode ray tube even if any load such as dropping impact be applied to the shadow mask.

Furthermore, according to the shadow mask of the first embodiment of the present invention, the balance in the strength of the shadow mask can be made extremely regular and uniform by continuously or intermittently changing the opening hole areas of the front surface side hole portions of the through holes formed to the shadow mask between the central portion and the peripheral portion of the shadow mask. As a result, the strength of the shadow mask can be made gradually larger from the center towards the periphery of the shadow mask, and even if any dropping impact be applied to the shadow mask after the mounting to the cathode ray tube, the shadow mask is free from any deformation.

Still furthermore, according to the second embodiment of the present invention, the balance in the strength of the shadow mask can be made extremely regular and uniform by prescribing the opening hole width T of the front surface side hole portion of the through hole formed at the peripheral portion in a predetermined range with respect to the plate thickness of the shadow mask and continuously changing this opening hole width T between the central portion and the peripheral portion of the shadow mask. As a result, even if any dropping impact be applied to the shadow mask after the mounting to the cathode ray tube, the shadow mask never be damaged or deformed.

It is to be noted that the present invention is not limited to the described embodiments and many other changes and modifications may be made without departing from the scopes of the appended claims.

The entire disclosure of Japanese Patent Applications No. 2000-246611 filed on Aug. 16, 2000 and No. 2000-283501 filed on Sep. 19, 2000 including the specifications, claims, drawings and summary are incorporated herein by reference in its entirety.

What is claimed is:

1. A shadow mask which has a front surface and a rear surface to which through holes are formed in a predetermined arrangement, each of said through holes having a rear surface side hole portion through which an electron beam enters and a front surface side hole portion through which the electron beam outgoes so as to form a beam spot having a predetermined shape on a surface to be irradiated,
wherein the front surface side hole portion of the through hole formed at a peripheral portion of the shadow mask has an opening hole area smaller than that of the front surface side hole portion of the through hole formed at a central portion thereof.

2. A shadow mask according to claim 1, wherein supposing that the opening hole area of the front surface side hole portion of the through hole formed at the central portion is 100, the opening hole area of the front surface side hole portion of the through hole formed at the peripheral portion is in a range of 80 to 96.

3. A shadow mask according to claim 1, wherein the opening hole areas of the front surface side hole portions of the through holes are continuously changed at a predetermined rate of change in accordance with a distance from the central portion of the shadow mask.

4. A shadow mask according to claim 1, wherein the through holes formed to an entire outer peripheral portion have opening hole areas having substantially the same size and the through holes formed between the through holes formed at the central portion of the shadow mask and the through holes formed to the entire outer peripheral portion have front surface side hole portions having opening hole areas continuously changed at a predetermined rate of change.

5. A shadow mask according to claim 1, wherein said shadow mask is mounted to a flat-type cathode ray tube.

6. A shadow mask which has a front surface and a rear surface to which through holes are formed in a predetermined arrangement, each of said through holes having a rear surface side hole portion through which an electron beam enters and a front surface side hole portion through which the electron beam outgoes so as to form a beam spot having a predetermined shape on a surface to be irradiated,
wherein the front surface side hole portion of the through hole formed at a peripheral portion of the shadow mask has substantially an elliptical shape in which an opening hole width in a direction normal to a virtual line extending from a center of the shadow mask is made smaller than that of the front surface side hole portion of the through hole formed at a central portion thereof.

7. A shadow mask according to claim 6, wherein the opening hole width of the front surface side hole portion of the through hole formed at the peripheral portion of the shadow mask has a size not less than 1.46 time of a thickness of the shadow mask.

8. A shadow mask according to claim 6, wherein the opening hole widths of all the front surface side hole portions including of the front surface side hole portions at the peripheral portion are continuously changed at a predetermined rate of change in accordance with a distance from the central portion of the shadow mask.

9. A shadow mask according to claim 6, wherein opening hole widths of all the front surface side hole portions including the front surface side hole portions at the peripheral portion are substantially the same at the front surface side hole portions at the outermost peripheral portion of the shadow mask and the opening hole widths of the front surface side hole portions of the through holes formed between the through holes formed at the central portion of the shadow mask and the through holes formed to the outermost peripheral portion are continuously changed at a predetermined rate of change.

10. A shadow mask according to claim 1, wherein said shadow mask is mounted to a flat-type cathode ray tube.
